(19) United States
(12) Patent Application Publication
(10) Pub. No.: US 2005/0030268 A1
(43) Pub. Date: Feb. 10, 2005

(54) Full-color electronic device with separate power supply lines

(76) Inventors: Weixiao Zhang, Goleta, CA (US); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/641,891

(22) Filed: Aug. 14, 2003

Related U.S. Application Data
(60) Provisional application No. 60/406,168, filed on Aug. 27, 2002.

(51) Int. Cl. G09G 3/32

(52) U.S. Cl. 345/83

(57) ABSTRACT

Different radiation-emitting elements can be supplied different power supply potentials during operation of a display. In a display for an electronic device, a full-color pixel can include a red subpixel, a green subpixel, and a blue subpixel. The subpixels may have light-emitting diodes that comprise organic active materials with different compositions that degrade over time at different rates. By using different power supply potentials for the different subpixels, better intensity and color control can be obtained for an electronic device.

### FIELD OF THE INVENTION

This invention relates in general to electronic devices, and more particularly, to electronic devices capable of emitting radiation from elements at different emission maxima.

### DESCRIPTION OF THE RELATED ART

Organic light-emitting diodes (“OLEDs”) have been viewed as novel display technologies for next generation flat-panel displays. One of the interests in OLEDs is for emissive displays with high information content. Such displays can be components for third generation cellular phones (also known as G3 phones or web phones), personal digital assistants (“PDAs”) or palm-sized personal computers, computer monitors and television screens.

For OLEDs to be used for high information content displays (e.g., larger than 320×240 pixels), an active matrix driving scheme is typically adopted. A typical pixel circuit for an OLED is shown in FIG. 1. The pixel 10 contains a red subpixel 12 having a red OLED 128, a green subpixel 14 having a green OLED 148, and a blue subpixel 16 having a blue OLED 168. Each subpixel has a latchable electric switch composing two thin-film transistors and a holding capacitor and a light emitter that includes an OLED. Data lines 121, 141, and 161 are connected to the subpixels 12, 14, and 16, respectively, and a common scan line 18 is connected to each of the subpixels. A common Vdd line 15 and a common Vss 19 are shared among the subpixels in a full-color pixel. Due to the different materials and characteristics among red, green and blue subpixel, the common Vdd line 15 and common Vss line 19 limit the performance of full color active matrix displays with respect to light intensity optimization, gamma correction, and color balance.

### SUMMARY OF THE INVENTION

Different radiation-emitting elements can be coupled to different power supplies and supplied different potentials during operation of a display. In a display for an electronic device, a full-color pixel can include a red subpixel, a green subpixel, and a blue subpixel. The subpixels may have organic active materials with different compositions that degrade over time at different rates. By using different power supply potentials for the different subpixels, better intensity and color control can be obtained for an electronic device.

In one set of embodiments, an electronic device can comprise a first light-emitting element and at least a second light-emitting element. Each of the first and second light emitting elements includes a first electrode and a second electrode. For example, the first electrodes may be anodes, and the second electrodes may be cathodes. The first light-emitting element can comprise a first organic material and be designed to have an emission maximum at a first wavelength, and the second radiation-emitting element can comprise a second organic material and be designed to have an emission maximum at a second wavelength that is different from the first wavelength. The electronic device can include a first power supply line and at least second power supply line, wherein the first and second power supply lines are capable of operating at significantly different potentials. The first power supply line may be coupled to the first electrode of the first radiation-emitting element, and at least the second power supply line coupled to the first electrode of the second radiation-emitting element.

In another set of embodiments, an electronic device can comprise a pixel comprising a red subpixel, a green subpixel, a blue subpixel. The electronic device can also comprise a first Vdd line coupled to the red subpixel, a second Vdd line coupled to the green subpixel, and a third Vdd line coupled to the blue subpixel. The electronic device can further comprise a first Vss line coupled the red subpixel, a second Vss line coupled the green subpixel, and a third Vss line coupled the blue subpixel. The device may be configured to allow that at least one of (i) the first, second, and third Vdd lines are capable of being operated at significantly different potentials and (ii) the first, second, and third Vss lines are capable of being operated at significantly different potentials.

Other sets of embodiments can include methods of operating the electronic devices.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes a schematic diagram of a single pixel having red, green, and blue subpixels (prior art).

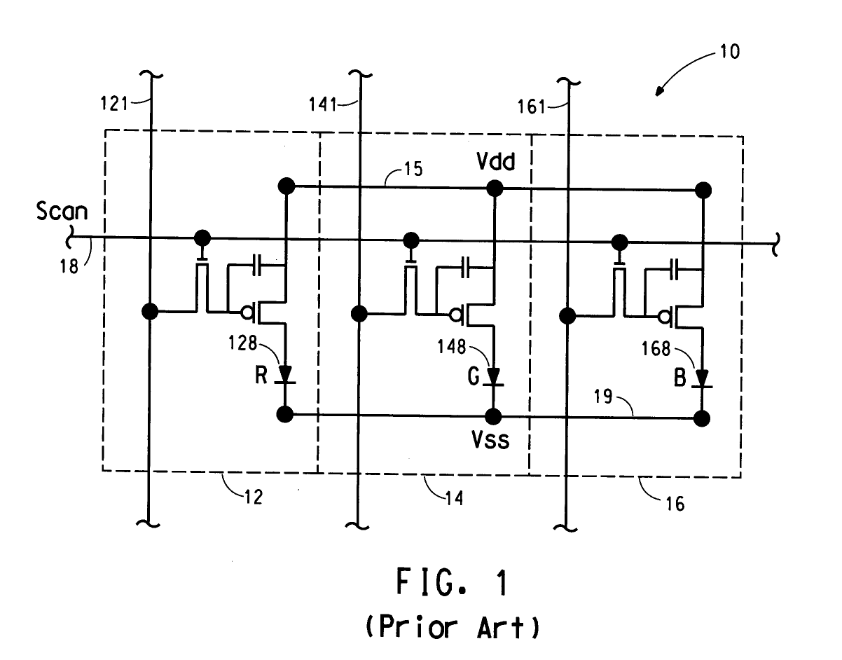

FIG. 2 includes a plot of current-voltage (I-V) characteristics from different color OLED elements.

FIG. 3 includes a plot of luminance-voltage (L-V) characteristics from different color OLED elements.

FIG. 4 includes a data set of operation lifetime among the different color OLED elements.

FIG. 5 includes a schematic diagram of a single pixel having red, green, and blue OLEDs with different power supply lines for the different subpixels.

FIG. 6 includes a schematic diagram of FIG. 5 with more circuit details.

FIG. 7 includes a schematic diagram for a portion of a matrix including a plurality of pixels.

FIG. 8 includes a schematic diagram of an electronic device that includes a display having full color pixels.

FIG. 9 includes a schematic diagram of a single pixel having red, green, and blue OLEDs with different power supply lines for the different subpixels in accordance with another embodiment.

FIG. 10 includes a plot of I-V characteristics of different colored pixels.

FIG. 11 includes a plot of L-V characteristics of different colored pixels.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Different radiation-emitting elements can be coupled to different power supplies and supplied different potentials during operation of a display. In a display for an electronic device, a full-color pixel can include a red subpixel, a green subpixel, and a blue subpixel. The subpixels may have light-emitting diodes that comprise organic active materials with different compositions that degrade over time at different rates. By using different power supply potentials for the different subpixels, better intensity and color control can be obtained for an electronic device.

Before addressing details of embodiments described below, some terms are defined or clarified. As used herein, the terms “array,” “peripheral circuitry” and “remote circuitry” are intended to mean different areas or components. For example, an array may include a number of pixels, cells, or other electronic devices within an orderly arrangement (usually designated by columns and rows) within a component. These electronic devices may be controlled locally on the component by peripheral circuitry, which may lie within the same component as the array but outside the array itself. Remote circuitry typically lies farther away from the array compared to the peripheral circuitry. Usually, peripheral circuitry is only used for access or providing information to an array. Remote circuitry may be used for functions not solely related to the array. Additionally, remote circuitry may lie within a different component compared to the array and can send signals to or receive signals from the array (typically via the peripheral circuitry).

The term “control electrode” is intended to mean an electrode that is used to control the flow of current through a transistor. For a bipolar transistor, the control electrode is the base (or base region). For a field-effect transistor, the control electrode is the gate (or gate electrode).

The term “coupled” is intended to mean a connection, linking, or association of two or more circuit elements, circuits, or systems in such a way that a potential or signal information may be transferred from one to another. Non-limiting examples of “coupled” can include direct connections between circuit elements, circuit elements with switch(es) (e.g., transistor(s)) connected between them, or the like.

The term “current-carrying electrode” is intended to mean an electrode of a transistor where current is intended to flow. For a bipolar transistor, the current-carrying electrodes are the collector (or collector region) and the emitter (or emitter region). For a field-effect transistor, the current-carrying electrodes are the source (or source region) and the drain (or drain region).

The term “emission maximum” is intended to mean the wavelength, in nanometers, at which the maximum intensity of electroluminescence is obtained. Electroluminescence is generally measured in a diode structure, in which the material to be tested is sandwiched between two electrical contact layers and a voltage is applied. The light intensity and wavelength can be measured, for example, by a photodiode and a spectrographer, respectively.

The term “pixel” is intended to mean the smallest complete unit of a display as observed by a user of the display. The term “subpixel” is intended to mean a portion of a pixel that makes up only a part, but not all, of a pixel. In a full-color display, a full-color pixel can comprise three sub-pixels with primary colors in red, green and blue spectral regions. A desired color can be obtained by combining the three primary colors with different intensities (gray levels). For instance, with 8-bit (256 level) gray levels for each sub-pixel, one can achieve 8³ or approximately 16.7 million color combinations. However, a red monochromatic display may only include red light-emitting elements. In the red monochromatic display, each red light-emitting element resides in a pixel. No subpixels are needed to distinguish among them. Therefore, whether a light-emitting element is a pixel or subpixel depends on the application in which it is used.

The term “significantly different potentials” is intended to mean potentials that have a different greater than a difference that occurs by mere line loss (e.g., parasitic resistance of a wire) or typical fluctuations seen in potentials (e.g., due to noise or other environmental conditions). For example, assume that due to parasitic resistance and noise between two points in a circuit causes a potential difference of no more than 0.02 volts when both points are to be at approximately 5.00 volts. If one of the points is at a potential of approximately 5.00 volts and the other point is at approximately 4.91 volts, then the points would be considered to be at significantly different potentials.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

To the extent not described herein, many details regarding specific materials, processing acts, and circuits are conventional and may be found in textbooks and other sources within the organic light-emitting display, photodetector, semiconductor and microelectronic circuit arts.

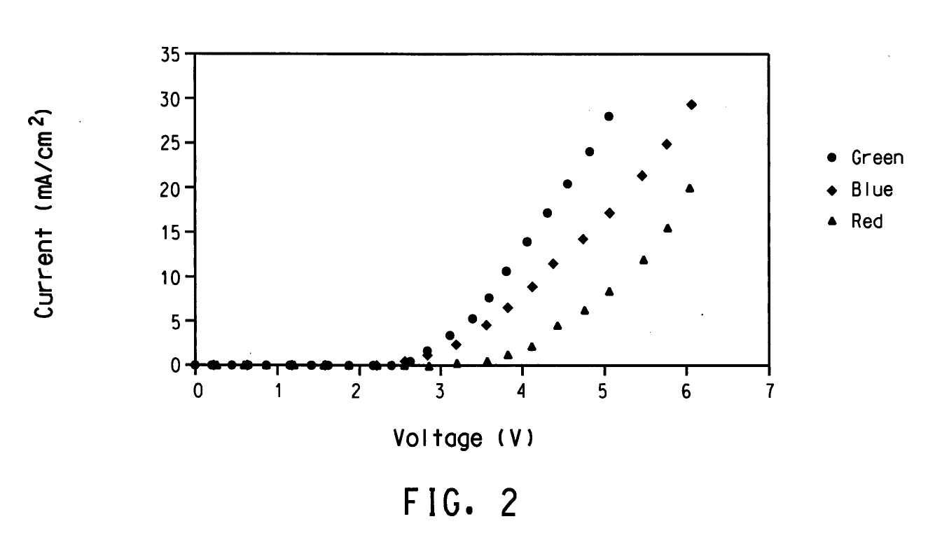

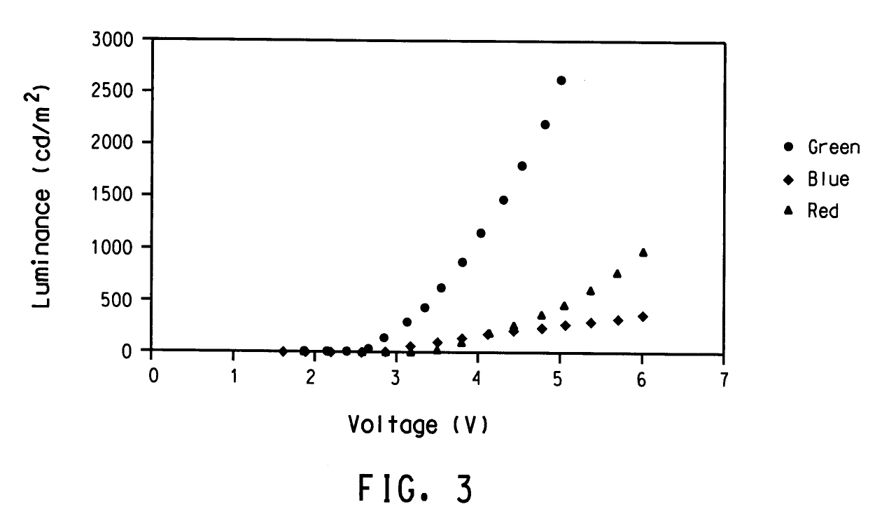

Before describing details of the circuitry of the devices, the need for different power supply potentials (e.g., different Vdd potentials or different Vss potentials) due to differences in materials and their degradation in radiation-emitting elements is addressed. FIGS. 2 and 3 include plots of the current-voltage (I-V) characteristics and luminance-voltage (L-V) characteristics, respectively, of red, green, and blue light-emitting elements. As can be seen in FIG. 3, the brightness for each light-emitting element is a function of biasing potential. If all three light-emitting elements are to emit the same intensity of light, different biasing potentials are needed for this specific example. Part of this difference is due to the fact that the composition of the organic active material within each of the elements is different. They may have different small molecule or polymeric compounds, or vary whether they have any fluorophores or dyes, and if so, potentially different fluorophores or dyes between different light-emitting elements.

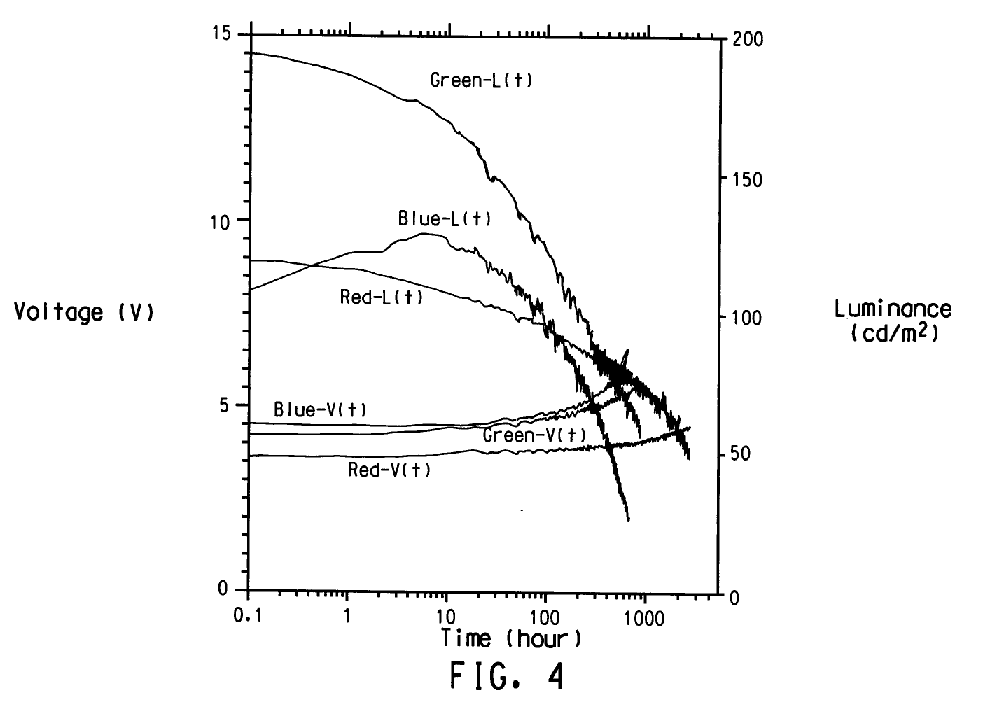

FIG. 4 includes an illustration of a plot of biasing voltage (the potential difference between the two terminals of a light-emitting element) versus time for the different light-emitting elements. In order to keep the same intensity for the same light-emitting element, a higher potential may be needed because the performance of the light-emitting element degrades with time. Note that the rate of change may differ between the different light-emitting elements.

Within a full-color pixel, each of its red, green, and blue subpixels need to have the capability to allow different biases across their respective OLED elements due to their different compositions and performance degradation characteristics. A circuit configuration with separate power lines allows better control of the color levels and intensities over the lifetime of the device.

Attention is now directed to details for implementing an electronic device having full-color pixels. The description begins with circuitry at the pixel and subpixel level, extends the circuitry to an array, and illustrates how the array may be used within an electronic device. The description of the figures is presented to illustrate better the invention and not to limit its scope.

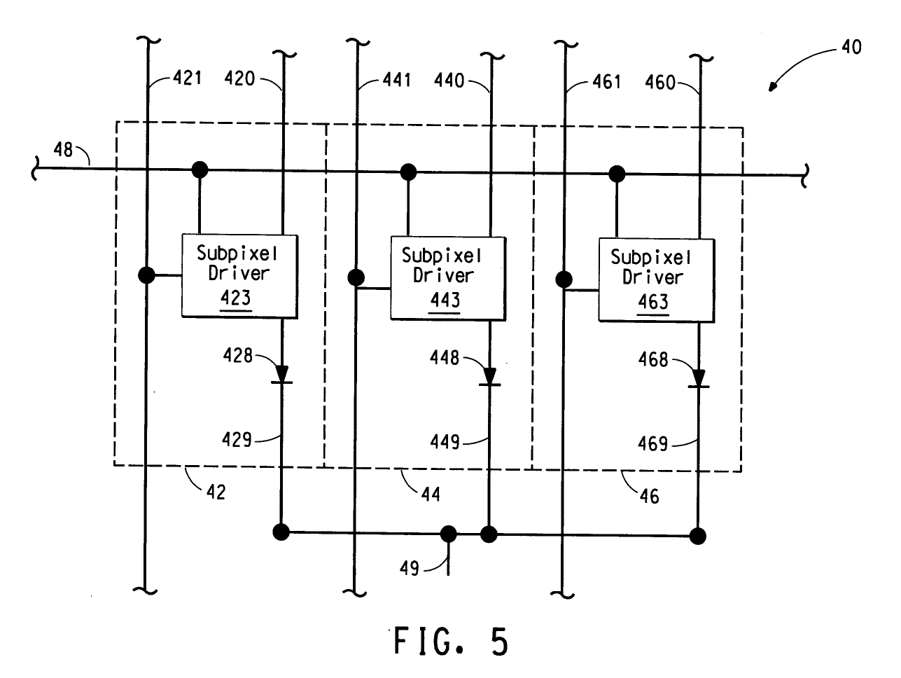

FIG. 5 includes a schematic diagram of a pixel 40. The pixel includes a red subpixel 42, a green subpixel 44, and a blue subpixel 46. A red Vdd line 420, a red Vss line 429, and a red data line 421 are coupled to the red subpixel 42, a green Vdd line 440, a green Vss line 449, and a green data line 441 are coupled to the green subpixel 44, and a blue Vdd line 460, a blue Vss line 469, and a blue data line 461 are coupled to the blue subpixel 46. The Vss lines 429, 449, and 469 are connected to a common Vss line 49. A common select line 48 is connected to each of the subpixels 42, 44, and 46. Each of the subpixels has subpixel drivers 423, 443, or 463 connected as shown in FIG. 5.

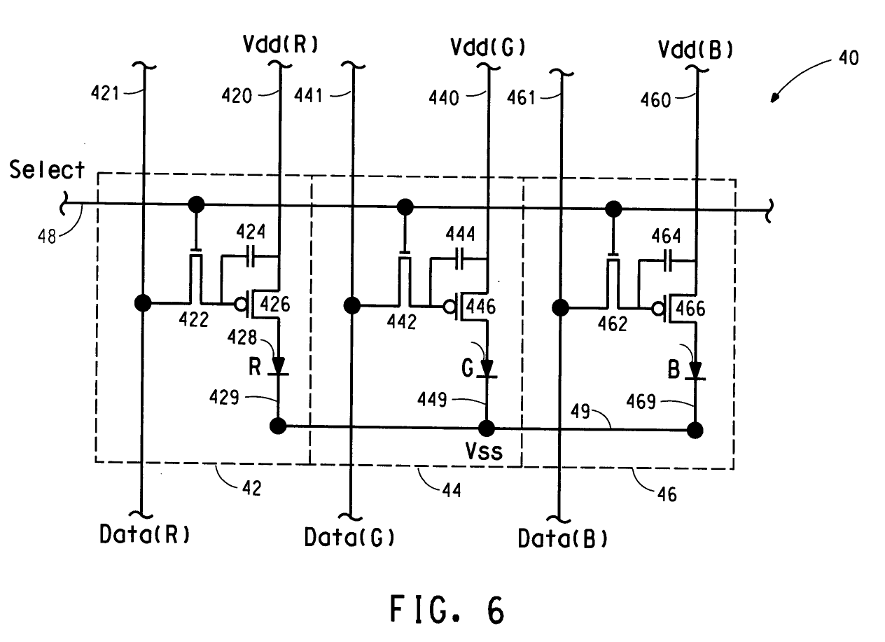

Referring to FIG. 6, each subpixel includes an n-channel transistor (422, 442, 462), a capacitor (424, 444, 464), a p-channel transistor (426, 446, 466), and a radiation-emitting element (428, 448, and 468). The source of the n-channel transistor (422, 442, 462) is connected to its corresponding data line (421, 441, 461). The drain of the n-channel transistor (422, 442, 462) is connected to an electrode of the capacitor (424, 444, 464) and a gate of the p-channel transistor (426, 446, 466). The other electrode of the capacitor (424, 444, 464) is connected to the source of the p-channel transistor (426, 446, 466) and the subpixel's corresponding Vdd line (420, 440, 460). The drain of the p-channel transistor (426, 446, 466) is connected to the anode of the light-emitting element (428, 448, 468). The cathode of the light-emitting element (428, 448, 468) is connected to the Vss line (429, 449, and 469), which is connected to the common Vss line 49. Within each subpixel shown in FIG. 6, all circuit elements except for the light-emitting element (428, 448, 468) form the subpixel driver for that subpixel.

In this particular embodiment, the light-emitting elements (428, 448, 468) are light-emitting diodes having an organic active material. The composition of the organic active material may be different between the red subpixel 42, the green subpixel 44, and the blue subpixel 46. Otherwise, the composition and structure of the other electrical components within the subpixels are substantially the same. The fabrication of the pixel 40 can be performed using conventional processes and materials.

Unlike a conventional pixel having a common Vdd line shared among the subpixels, pixel 40 has separate Vdd lines 420, 440, and 460 for the subpixels 42, 44, and 46, respectively. The separate Vdd lines allow for better control of color over the visible light spectrum within the full-color pixel 40. The separate Vdd lines can be used to adjust for differences in voltage used when the light-emitting elements 428, 448, and 468 have different compositions, as they degrade at different rates, or potentially other factors. Therefore, the separate Vdd lines for each subpixel 42, 44, and 46 allow for better intensity and color control over each of the subpixels.

During operation of the full-color pixel 40, data along data lines 421, 441, and 461 are set at potentials corresponding to whether or not its corresponding subpixel is to be activated. If light is to be emitted from the subpixel, the potential on the data line may be relatively lower than the potential on the corresponding Vdd line for that subpixel. In one non-limiting embodiment, a potential of approximately Vss may be along the data line if its corresponding subpixel is to be turned on. Conversely, if the subpixel is to remain or be turned off, the potential on the data line may be at or higher than a potential of the corresponding Vdd line for that subpixel. When the power supply lines and data lines are supplied with approximately the desired potentials, the select line 48 is activated to allow the pixel 40 to emit radiation corresponding to the data. Note that “emit radiation” should be construed to include emitting no radiation when the potential on the data lines of the subpixels in a pixel are relatively high (high enough to keep the p-channel transistors from turning on) while the select line 48 is activated.

In other embodiments, different potentials may be used for the data lines and select line for the pixel 40. For example, the potential of the select line 48 when active needs to be at least the threshold voltage for the n-channel transistors 422, 442, and 462. The potentials for each the data lines may be at least a sum of approximately the threshold voltage of the p-channel transistor and potential drop across the n-channel transistor when the n-channel transistor is on (enabled or activated). After reading this specification, skilled artisans will be able to determine potentials used for the power supply lines (Vdd lines 420, 440, 460 and Vss line 49), the data lines 421, 441, and 461, and the select line 48.

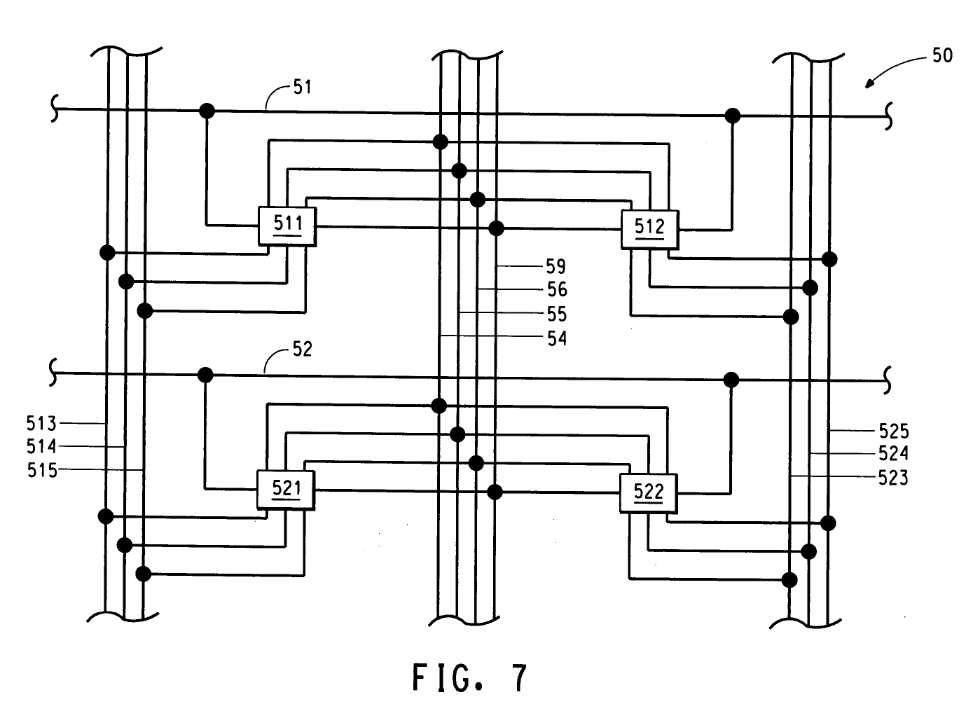

FIG. 7 includes a schematic diagram of a portion of an array 50 of pixels. As illustrated, the array 50 includes full-color pixels 511, 512, 521, and 522. Each of the full-color pixels can be similar to the full-color pixel 40 as shown in FIG. 5. Referring to FIG. 7, the array 50 is oriented in rows and columns of pixels. A first select line 51 is coupled to pixels 511 and 512, and a second select line 52 is coupled to pixels 521 and 522. The select lines 51 and 52 correspond to rows of the pixels within the array 50. Red data line 513, green data line 514, and blue data line 515 are coupled to the pixels 511 and 521, and red data line 523, green data line 524, and blue data line 525 are coupled to the pixels 512 and 522. The data lines are oriented in columns such that pixels in each column share the same data lines. The power supply lines are oriented such that they are shared between two columns of pixels. Red Vdd line 54, green Vdd line 55, blue Vdd line 56, and Vss line 59 are coupled to each of the pixels as illustrated in FIG. 7. Although not shown, these same power supply lines may be shared with all other pixels (not shown) within array 50. After reading this specification, skilled artisans will appreciate that other layouts and configurations may be possible. For example, the select lines may be oriented along columns, and the data lines may be oriented along rows.

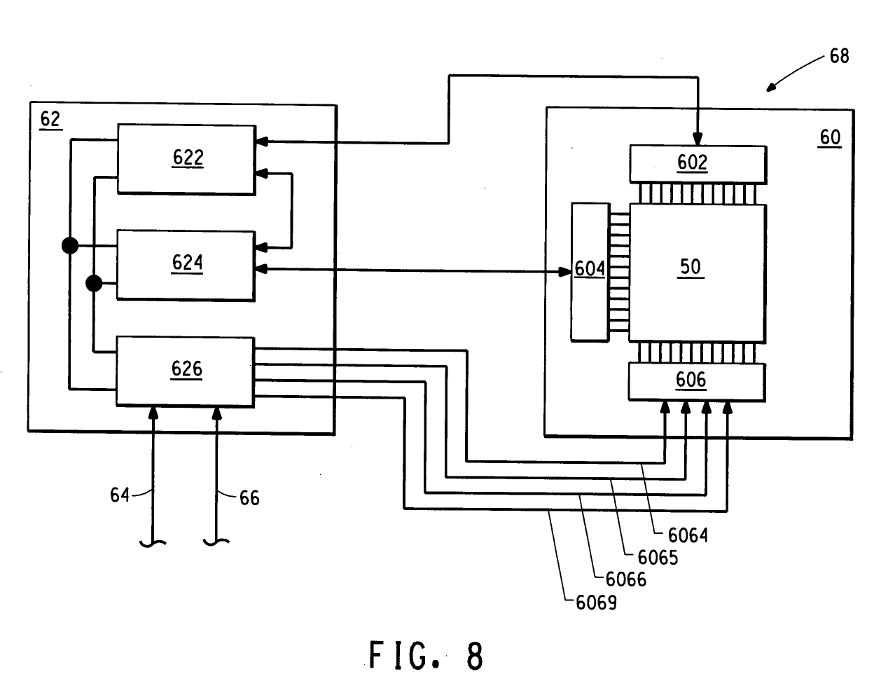

FIG. 8 includes a schematic diagram of an electronic device 68 including a display 60 and an integrated circuit 62. The electronic device 68 may include a G3 phone or web phone, a PDA or palm-sized personal computer, a computer monitor or television screen, or the like. In this non-limiting example, the integrated circuit 62 may control the operation of the display 60. The display 60 includes the matrix 50 as described in FIG. 7. In this specific example, the integrated circuit 62 includes the remote circuitry and the display 60 includes the array 50 and the peripheral circuitry. In other embodiments, some or all of the remote circuitry may reside within the display 60.

Referring to FIG. 8, the display 60 further includes a series of data lines connected to a column decoder 602, and a row array strobe (“RAS”) 604 to control the activation and deactivation of the select lines in the array 50. RAS 604 can perform a scanning function to allow rows to be serially activated and deactivated. The scanning frequency is typically high enough so that a human viewing the display 60 does not notice the scanning of the array 50.

The integrated circuit 62 includes a data line controller 622, a RAS controller 624, and a power supply controller 626. The data line controller 622 is coupled to the column decoder 602 and RAS controller 624. The RAS controller 624 is coupled to the RAS 604. The operation of the data line controller 622 and the RAS controller 624 is synchronized to allow the proper display of information by the display 60.

The power supply controller 626 may receive a first potential 64 and a second potential 66 from external sources via electrodes near the outside of the integrated circuit 62. For example, the first potential 64 may be Vssᵢₙ, and the second potential may be a Vddᵢₙ. The potential of the Vssᵢₙ may be at substantially zero volts or ground potential, and Vddᵢₙ may be any potential commonly used for Vdd within the microelectronics industry and may include 12 volts, 7.5V, 5.0 volts, 3.3 volts, or the like. The Vssᵢₙ and Vddᵢₙ potentials may be routed through the power supply controller 626 to the controllers 622 and 624 without any significant change in potential. Otherwise, conventional circuitry may be used to change the potentials and may include DC-DC step-up converters, DC-DC step-down converters, DC-DC inverting converters, charge pumps, resistors, or the like.

Power supply controller 626 also can be used to adjust the potentials being directed to the array power supply 606. The power supply controller 626 may adjust the Vddᵢₙ potential to the different potentials for the red Vdd power supply line 6064, the green Vdd power supply line 6065, the blue Vdd power supply line 6066, and the Vss power supply line 6069. DC-DC step-up converters, DC-DC step-down converters, DC-DC inverting converters, charge pumps, resistors, or other conventional circuitry may be used to adjust the Vddᵢₙ and Vssᵢₙ potentials 66 and 64 to other Vdd and Vss potentials used for the red, green, and blue subpixels within array 50.

Power controller 626 may include logic to compensate for potential degradation of intensity of light emitted by the subpixels over time. Therefore, the power supply controller 626 may be coupled to a clock signal that is internally generated within the integrated circuit 62 or provided by an external clock signal (not shown). The configuration shown allows for independent control of the potentials for the red, green, and blue subpixels within array 50. A function of the array power supply 606 can be to route the potentials from the power supply lines 6064, 6065, 6066, and 6069 to the different pixels and subpixels within the array 50.

Although not shown, other electrical connections between the integrated circuit 62 and the display 60 may be present. Also, many other electrodes may be connected to the integrated circuit 62 or display 60 to provide data or allow for the proper electrical performance of the electronic device 68. Such circuitry is conventional.

The intensity of radiation from each of the radiation-emitting elements 428, 448, and 468 is a function of the bias across the diode, as opposed to the actual potential of just the anode or just the cathode in isolation. The potentials on the anode and cathode may be positive, negative, zero, or any combination thereof.

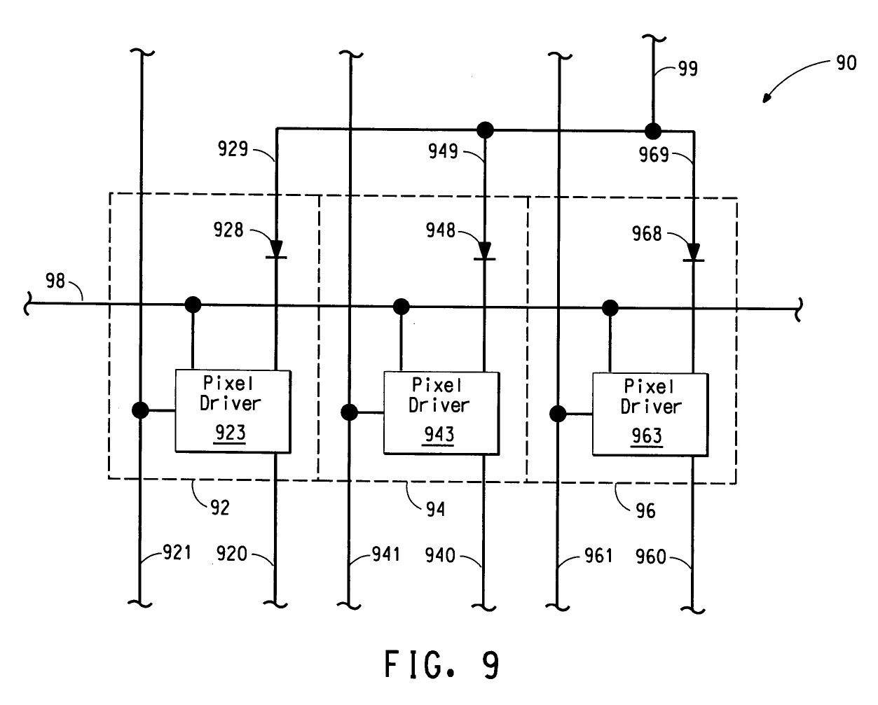

FIG. 9 illustrates another embodiment. FIG. 9 differs from FIG. 5 by having the subpixel drivers connected between the radiation-emitting elements and the Vss lines, and the subpixels use substantially the same Vdd potential but can use significantly different Vss potentials. More specifically, FIG. 9 includes a schematic diagram of a pixel 90 that includes a red subpixel 92, a green subpixel 94, and a blue subpixel 96. A red Vdd line 929, a red Vss line 920, and a red data line 921 are coupled to the red subpixel 92, a green Vdd line 949, a green Vss line 940, and a green data line 941 are coupled to the green subpixel 94, and a blue Vdd line 969, a blue Vss line 960, and a blue data line 961 are coupled to the blue subpixel 96. The Vdd lines 929, 949, and 929 are connected to a common Vdd line 99. A common select line 98 is connected to each of the subpixels 92, 94, and 96. Each of the subpixels has subpixel drivers 923, 943, or 963 connected as shown in FIG. 9.

The pixel 90 may be incorporated into a display and electronic device similar to that shown in FIGS. 7 and 8 except that different Vss lines within the display would be used instead of different Vdd lines. In still another embodiment (not shown), each of the Vdd lines and Vss lines within a pixel may be controlled independently of one another.

In still other embodiments, different subpixel driver circuitry can be used instead of circuitry shown in FIG. 6. For example, two n-channel transistors, two p-channel transistors, a p-channel selection transistor, an n-channel power transistor or any combination thereof may be used. Also, a subpixel driver may include more than two transistors. Further, the storage capacitor may also be connected to the Vss line, particularly for the subpixel drivers 923, 943, and 963 shown in FIG. 9. In another alternative embodiment, one or more field-effect transistors within the subpixel drivers may be replaced by one or more bipolar transistors. After reading this specification, skilled artisans will understand how to reconfigure the subpixel drivers for the bipolar transistor(s).

After reading this specification, skilled artisans will appreciate that the embodiments illustrated and described herein provide only a small sampling of potential embodiments. Other embodiments using different circuitry can allow for the independent control power supply lines to different radiation-emitting elements. The embodiments may be used for any OLEDs including polymeric OLEDs (“PLEDs”), small molecules OLEDs (SMOLEDs”), and combinations of different types of OLEDs. The embodiments described herein can allow for better control of color level and intensity by allowing the power supply potentials to the subpixels within a pixel to be independently controlled. The independent control can allow the potential on any one or more of the power supply lines to be the same or different for the subpixels within a pixel. Although additional power supply lines are needed within the array, the implementation can be accomplished with little, if any, difficulty. The concepts described herein may be extendable to other radiation sources that have radiation-emitting elements with different emission maxima. At least two radiation-emitting elements may be present. The examples described above are useful for radiation within the visible light spectrum (wavelengths of approximately 400-700 nm) having subpixels with emission maxima corresponding to red light, green light, and blue light. Additional subpixels can be used but are not needed because virtually all colors within the visible light spectrum can be generated by the three subpixels.

### EXAMPLES

The following specific examples are meant to illustrate and not limit the scope of the invention.

### Example 1

This example demonstrates that the colored OLEDs can be used for emitting elements in full-color displays.

Red, green and blue color OLED elements can be fabricated with three luminescent polymers emitting red, green, and blue light. Each of the PLEDs has a structure of ITO/buffer polymer/emitting polymer/cathode. Such a structure and its fabrication are conventional. Polyaniline (“PANi”) or poly(3,4-ethylendioxythiophene) (“PEDOT”) can be used as the buffer polymer layer. Low work function metals (such as Ba or Ca) are used as the cathode contact in this example. The low work function metal may be covered with an aluminum layer to improve electric conduction and environmental stability.

The Commission Internationale de l'Eclairage (CIE) color coordinates are shown in Table 1 and compared to those recommended by the display industry for High-Definition TeleVision (HDTV).

TABLE 1

| Color | Color coordinates | HDTV standard |
|---|---|---|
| Red | x = 0.62, y = 0.37 | x = 0.64, y = 0.33 |
| Green | x = 0.38, y = 0.58 | x = 0.29, y = 0.60 |
| Blue | x = 0.15, y = 0.13 | x = 0.15, y = 0.06 |

### Example 2

This example demonstrates that the operation voltages for different color elements can be different. Also, the red, green and blue OLED emitters can be powered by commercially-available integrated circuits.

Red, green and blue PLED emitters of Example 1 may have I-V and L-V characteristics as shown in FIGS. 2 and 3. Table 2 provides the operation voltages at 200 cd/m².

TABLE 2

| | Operation Voltage |
|---|---|
| Color | at 200 cd/m² |
| Red | 5.0 V |
| Green | 3.0 V |
| Blue | 4.4 V |

### Example 3

This example demonstrates that the operation voltages for different color subpixels are different at a different luminance compared to Example 2.

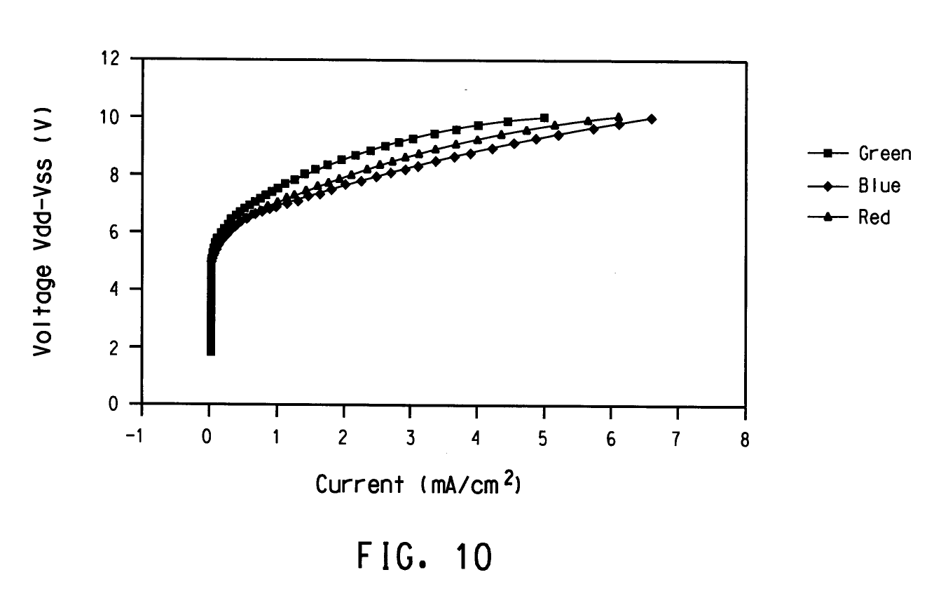

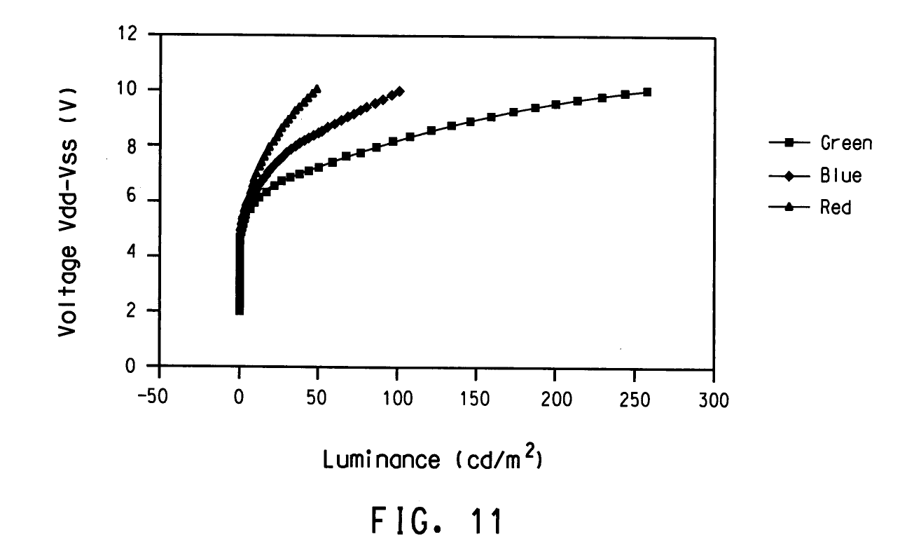

Red, green and blue PLED emitters from Example 2 may be part of an active matrix substrate with pixel circuits shown in FIG. 6. I-V and L-V characteristics are shown in FIGS. 10 and 11. Table 3 provides the operation voltage V_{dd} at 40 cd/m² with Vₛₛ=−2V. The aperture ratio for each subpixel (red, green, and blue) to one full-color pixel is 0.11.

TABLE 3

| | Operation Voltage |
|---|---|
| Color | V_{dd} at 40 cd/m² |
| Red | 7.4 V |
| Green | 5.1 V |
| Blue | 5.9 V |

### Example 4

This example demonstrates that a desired color at a given brightness can be achieved by proper combination of the three color sub-pixels.

Red, green and blue PLED emitters are part of an active matrix substrate with pixel circuits shown in FIG. 6. The Vdd voltages are adjusted for each color subpixels so that a paper white area luminescence is achieved (with color coordinates x=0.33, y=0.31 and area luminescent intensity of 200 cd/m²). The corresponding voltages of Vdd lines are shown in Table 4. In this example, Vₛₛ is set at −3 V.

TABLE 4

| Color | V_{dd} (V) |
|---|---|
| Red | 6.5 V |
| Green | 5.3 V |
| Blue | 5.0 V |

### Example 5

This example demonstrates that high information content, high display quality, full-color PLED displays can be achieved with the pixel design disclosed in this specification.

Red, green and blue PLED emitters can be part of an active matrix (AM) substrate with pixel circuits shown in FIG. 6. The pitch size of the full-color pixel can be 254 micron. The size of each subpixel is approximately 85×254 microns². The AM substrate can include poly-silicon materials with integrated row and column drivers as shown in FIG. 7. A timer and controller circuit can be part of a display system (as described in FIG. 8). Full-color images can be produced from this panel with Vₛₛ=−3V and Vdd lines of 8V, 7V, 8.5V for red, green and blue subpixels, respectively. In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. An electronic device comprising:
a first radiation-emitting element comprising a first electrode and a second electrode, wherein the first radiation-emitting element comprises a first organic active material and is designed to have an emission maximum at a first wavelength;
a second radiation-emitting element comprising a first electrode and a second electrode, wherein the second radiation-emitting element comprises a second organic active material and is designed to have an emission maximum at a second wavelength that is different from the first wavelength;
a first power supply line coupled to the first electrode of the first radiation-emitting element;
a second power supply line coupled to the first electrode of the second radiation-emitting element,
wherein the electronic device is capable of having:
the first and second power supply lines operating at significantly different potentials; and
a biasing configuration selected from:
each of the first electrodes is configured to receive a higher potential compared to each of the second electrodes; and
each of the first electrodes is configured to receive a lower potential compared to each of the second electrodes.

2. The electronic device of claim 1, wherein the electronic device include a pixel that comprises the first radiation-emitting element and second radiation-emitting element, and a third radiation-emitting element.

3. The electronic device of claim 1, wherein the second electrodes are configured to receive substantially a same potential.

4. The electronic device of claim 1, wherein the electronic device comprises a display having an active matrix of light-emitting diodes, wherein the light-emitting diodes include the first and second radiation-emitting elements.

5. An electronic device comprising a first pixel comprising:
a red subpixel;
a green subpixel;
a blue subpixel;
a first Vdd line coupled to the red subpixel;
a second Vdd line coupled to the green subpixel;
a third Vdd line coupled to the blue subpixel;
a first Vss line coupled the red subpixel;
a second Vss line coupled the green subpixel; and
a third Vss line coupled the blue subpixel,
wherein the device is configured to allow that at least one of:
the first, second, and third Vdd lines are capable of being operated at significantly different potentials; and
the first, second, and third Vss lines are capable of being operated at significantly different potentials.

6. The electronic device of claim 5, wherein the first, second, and third Vdd lines are capable of being operated at significantly different potentials.

7. The electronic device of claim 5, wherein the first, second, and third Vss lines are capable of being operated at significantly different potentials.

8. The electronic device of claim 5, wherein each of the red, green, and blue subpixels comprises a first transistor having a first current-carrying electrode, a second current-carrying electrode, and a control electrode; a capacitor having a first electrode and a second electrode; a second transistor having a first current-carrying electrode, a second current-carrying electrode, and a control electrode; and a first light-emitting element having an anode and a cathode, wherein:
the first current-carrying electrode of the first transistor is connected to a data line, the second current-carrying electrode of the first transistor is connected to the first electrode of the capacitor and the control electrode of the second transistor, and the control electrode of the first transistor is connected to a select line;
the second electrode of the capacitor is connected to the first current-carrying electrode of the second transistor;
the second current-carrying electrode of the second transistor is connected to the anode of the light-emitting element; and
the cathode of the light-emitting element is connected to a common Vss line.

9. The electronic device of claim 8, wherein:
within the red subpixel, the second electrode of the capacitor and the first current-carrying electrode of the second transistor are connected to the first Vdd line;
within the green subpixel, the second electrode of the capacitor and the first current-carrying electrode of the second transistor are connected to the second Vdd line; and
within the blue subpixel, the second electrode of the capacitor and the first current-carrying electrode of the second transistor are connected to the third Vdd line.

10. The electronic device of claim 5, wherein the red, green, and blue subpixels are coupled to different data lines and are coupled to a common select line.

11. The electronic device of claim 5, wherein the electronic device comprises a plurality of pixels including the first pixel, wherein:
the plurality of pixels is oriented in rows and columns;
all red subpixels within the plurality of pixels are connected to the first Vdd line;
all green subpixels within the plurality of pixels are connected to the second Vdd line; and
all blue subpixels within the plurality of pixels are connected to the third Vdd line.

12. The electronic device of claim 11, wherein:
all red subpixels that are connected to a same select line have different data lines connected to each of those red subpixels;
all green subpixels that are connected to the same select line have different data lines connected to each of those green subpixels; and
all blue subpixels that are connected to the same select line have different data lines connected to each of those blue subpixels.

13. The electronic device of claim 5, wherein the first, second, and third Vdd lines are connected to a common Vdd electrode for a display, and each of the first, second, and third Vss lines are designed to operate at a potential lower than the common Vdd electrode.

14. The electronic device of claim 5, wherein the first, second, and third Vss lines are connected to a common Vss electrode for a display, and each of the first, second, and third Vdd lines are designed to operate at a potential higher than the common Vss electrode.

15. A method of using an electronic device including a first radiation-emitting element having a first organic active material and a first emission maximum and a second radiation-emitting element having a second organic active material and a second emission maximum different from the first emission maximum, wherein the method comprises:
supplying a first potential to a first power supply line that is coupled to a first electrode of the first radiation-emitting element;
supplying a second potential to a second power supply line that is coupled to a second electrode of the first radiation-emitting element;
supplying a third potential to a first power supply line that is coupled to a first electrode of the second radiation-emitting element; and
supplying a fourth potential to a second power supply line that is coupled to a second electrode of the second radiation-emitting element,
wherein:
the first and second potentials are at significantly different potentials; and
the electronic device has a biasing condition selected from:
each of the first electrodes is at a higher potential compared to each of the second electrodes; and
each of the first electrodes is at a lower potential compared to each of the second electrodes.

16. The method of claim 15, wherein:
the first and second radiation-emitting elements are light-emitting diodes;
the first electrodes are anodes of the light-emitting diodes;
the second electrodes are cathodes of the light-emitting diodes;
the first and second potentials are significantly different potentials; and
the third and fourth potentials are at substantially a same potential.

17. The method of claim 15, further comprising:
supplying fifth and sixth potentials to the first and second radiation-emitting elements, respectively, wherein the fifth and sixth potentials correspond to information to be displayed by the first and second radiation-emitting elements; and
activating a select line coupled to the first and second radiation-emitting elements.

18. The method of claim 15, wherein the first and second radiation-emitting elements are part of a first pixel.

19. The method of claim 18, wherein the electronic device includes a display comprising a plurality of pixels including the first pixel.

20. The method of claim 19, wherein:
each pixel of the plurality of pixels includes the first radiation-emitting element, the second radiation-emitting element, and a third radiation-emitting element; and
the first radiation-emitting element has a first emission maximum corresponding to red light;
the second radiation-emitting element has a first emission maximum corresponding to green light; and
the third radiation-emitting element has a first emission maximum corresponding to blue light.
